(19) United States
(12) Patent Application Publication
(10) Pub. No.: US 2020/0151647 A1
(43) Pub. Date: May 14, 2020

(54) RECOMMENDING JOBS BASED ON TITLE TRANSITION EMBEDDINGS

(71) Applicant: Microsoft Technology Licensing, LLC, Redmond, WA (US)

(72) Inventors: Girish Kathalagiri Somashekariah, Santa Clara, CA (US); Huichao Xue, Santa Clara, CA (US); Ye Yuan, Mountain View, CA (US); Meng Meng, San Jose, CA (US); Ada Cheuk Ying Yu, Santa Clara, CA (US)

(73) Assignee: Microsoft Technology Licensing, LLC, Redmond, WA (US)

(21) Appl. No.: 16/185,272

(22) Filed: Nov. 9, 2018

(51) Int. Cl. G06Q 10/06; G06N 99/00

(52) U.S. Cl. CPC G06Q 10/063112; G06N 99/005

(57) ABSTRACT

The disclosed embodiments provide a system for recommending jobs based on title transition embeddings. During operation, the system obtains a word embedding model of job histories of members of an online network. Next, the system applies the word embedding model to a first set of attributes associated with a title of a candidate to produce a first embedding. The system also applies the word embedding model to a second set of attributes associated with a job title of a job to produce a second embedding. The system then calculates a similarity between the first and second embeddings. Finally, the system outputs the similarity for use in recommending the job to the candidate.

### RELATED APPLICATIONS

The subject matter of this application is related to the subject matter in a co-pending non-provisional application and filed on the same day as the instant application, entitled “Ranking Job Recommendations Based on Title Preferences,” having Ser. No. ______, and filing date ______ (Attorney Docket No. LI-902371-US-NP).

The subject matter of this application is also related to the subject matter in a co-pending non-provisional application and filed on the same day as the instant application, entitled “Activity-Based Inference of Title Preferences,” having Ser. No. ______, and filing date ______ (Attorney Docket No. LI-902374-US-NP).

### BACKGROUND

### Field

The disclosed embodiments relate to user recommendations. More specifically, the disclosed embodiments relate to techniques for recommending jobs based on title transition embeddings.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of recommending jobs based on title transition embeddings in accordance with the disclosed embodiments.

FIG. 4 shows a flowchart illustrating a process of producing a word embedding model of job histories in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for ranking job recommendations. The job recommendations may be customized to users that browse and/or search for job postings, users that are identified as job seekers, and/or other types of candidates for jobs. For example, the job recommendations may include jobs that are matched to the candidates' education, work experience, skills, level of seniority, location, current titles, and/or past titles.

More specifically, the disclosed embodiments provide a method, apparatus, and system for ranking job recommendations based on title transition embeddings. The title transition embeddings may include word embeddings for past and current titles of a set of users, such as job candidates and/or members of an online network. For example, a word embedding model may be trained using a collection and/or series of standardized job titles, industries, company names, schools, and/or fields of study in each user's education and/or job history. The word embedding model may then be used to convert titles and/or other attributes in the job histories into embeddings that are vector representations of the attributes.

As a result, the word embedding model may capture patterns and/or semantic relationships among titles in the users' job histories, so that similarities and/or trends in titles within the job histories are reflected in calculations of similarity between the corresponding embeddings. For example, a cosine similarity that is calculated between two titles that are frequently found together in the users' job histories may be higher than a cosine similarity that is calculated between two titles that are not typically found together in the job histories.

In turn, similarities between embeddings of titles may be used to generate recommendations of jobs to a set of candidates. For example, one or more cosine similarities may be calculated between the embedding of a job's title and embeddings of a candidate's current title, past titles, and/or preferred title (e.g., the candidate's preferred “next step” in his/her career path). Next, the cosine similarities may be inputted with other features into a machine learning model that predicts the candidate's likelihood of applying to the job. Scores from the machine learning model may then be used to rank a set of jobs and select a highest-ranked subset of the jobs as recommendations for the candidate.

By inputting embeddings that capture title transition relationships and/or trends into machine learning models that are used to generate and/or rank job recommendations, the disclosed embodiments may identify and recommend jobs that are similar and/or relevant to the candidates' job histories, independent of the candidates' job searches and/or title preferences. In contrast, conventional techniques may generate recommendations based on exact matches with the candidates' job search queries and/or title preferences, thereby limiting the recommendations to a small and/or narrow set of jobs. Consequently, the disclosed embodiments may improve computer systems, applications, user experiences, tools, and/or technologies related to user recommendations, employment, recruiting, and/or hiring.

### Recommending Jobs Based on Title Transition Embeddings

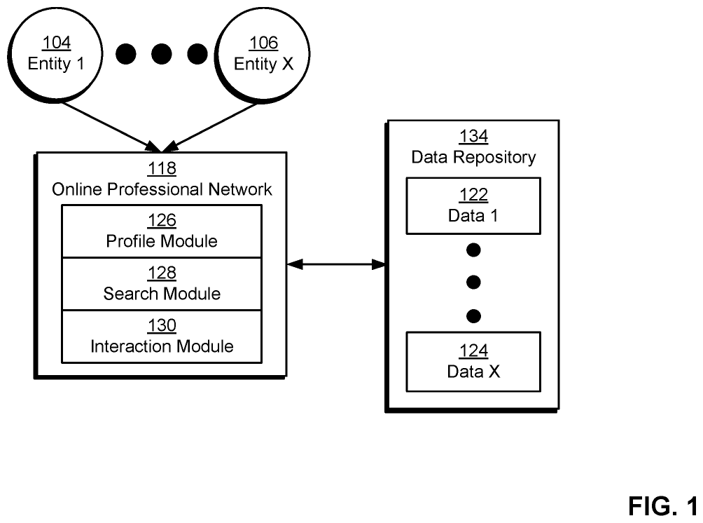

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings of candidates for jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strength of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

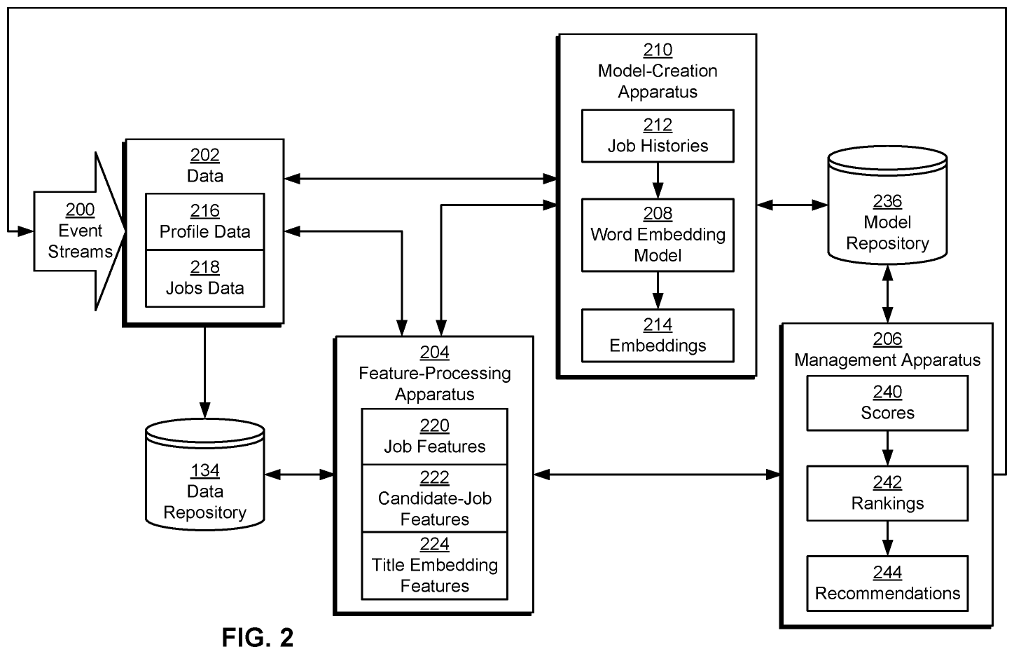

In one or more embodiments, online network 118 includes functionality to improve the timeliness, relevance, and/or accuracy of job recommendations outputted to the candidates. As shown in FIG. 2, data repository 134 and/or another primary data store may be queried for data 202 that includes profile data 216 for members of an online network (e.g., online network 118 of FIG. 1), as well as jobs data 218 for jobs that are listed or described within or outside the online network. Profile data 216 includes data associated with member profiles in the online network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online network.

Attributes of the members from profile data 216 may be matched to a number of member segments, with each member segment containing a group of members that share one or more common attributes. For example, member segments in the online network may be defined to include members with the same industry, title, location, and/or language.

Connection information in profile data 216 may additionally be combined into a graph, with nodes in the graph representing entities (e.g., users, schools, companies, locations, etc.) in the online network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 may include structured and/or unstructured data for job listings and/or job descriptions that are posted and/or provided by members of the online network. For example, jobs data 218 for a given job or job listing may include a declared or inferred title, company, required or desired skills, responsibilities, qualifications, role, location, industry, seniority, salary range, benefits, and/or member segment.

Profile data 216 and/or jobs data 218 may further include job histories 212 of members of the online network. Each job history may include a chronological sequence of jobs for a given member that terminates in the member's current job and/or the member's most recently listed job. As a result, the job history may be assembled from current and/or previous jobs listed in the member's current profile data 216. For example, the job history may include titles, companies, locations, industries, seniorities, locations, and/or other attributes of the member's current and/or previous jobs. The job history may optionally include schools, fields of study, and/or degrees from the member's educational background.

Job histories 212 may be supplemented with job listings, job descriptions, and/or other information in jobs data 218. For example, a job listing that is posted in the online network may be matched to a member that applies for and subsequently accepts an offer for the corresponding job. In turn, the job in the member's job history may be populated and/or associated with skills, benefits, qualifications, requirements, salary information, and/or other information from the job listing.

In one or more embodiments, data repository 134 stores data that represents standardized, organized, and/or classified attributes in profile data 216 and/or jobs data 218. For example, skills in profile data 216 and/or jobs data 218 may be organized into a hierarchical taxonomy that is stored in data repository 134. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.).

Data 202 in data repository 134 may further be updated using records of recent activity received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the community may be generated in response to the activity. The record may then be propagated to components subscribing to event streams 200 on a nearline basis.

A feature-processing apparatus 204 uses data 202 from event streams 200 and/or data repository 134 to calculate features for a candidate and/or one or more jobs. For example, feature-processing apparatus 204 may execute on an offline, periodic, and/or batch-processing basis to produce features for a large number of candidates and/or candidate-job pairs (e.g., combinations of members in the community and jobs for which the members are qualified). In another example, feature-processing apparatus 204 may generate features in an online, nearline, and/or on-demand basis based on recent job-seeking activity by a candidate (e.g., a user session with the community, a job search, a job view, a click on a job, an application for a job, etc.).

More specifically, feature-processing apparatus 204 may generate job features 220 for jobs, candidate-job features 222 for candidate-job pairs, and/or title embedding features 224 for candidates and/or jobs. Job features 220 may include attributes related to a listing of an opportunity. For example, job features 220 may include declared or inferred attributes of a job (e.g., from jobs data 218), such as the job's title, company (i.e., employer), industry, seniority, desired skill and experience, salary range, and/or location.

One or more job features 220 may also be derived features that are generated from other types of features. For example, job features 220 may provide a context of each candidate's impression of a job listing or job description. The context may include a time and location at which the job listing or description is viewed by the candidate. The location can encompass physical and/or other types of locations, such as a geographic location, an application (e.g., native application, mobile application, web application, a specific version of an application, etc.), a website, and/or a web page.

Candidate-job features 222 may include metrics and/or attributes related to a candidate's compatibility and/or interaction with a listing for a job or other type of opportunity. For example, candidate-job features 222 may include a match score between the member and the opportunity, which can be calculated based on overlap or commonality between the member's attributes in profile data 216 and the corresponding attributes in jobs data 218 for the opportunity (e.g., similarity in country, seniority, industry, and/or function between the member and opportunity). In another example, candidate-job features 222 may include cross products, cosine similarities, Jaccard similarities, Euclidean distances, and/or other measures of similarity between the candidate's skills and skills listed in the job; the candidate's current title and/or past titles and the job's title; and/or the candidate's headline and/or summary (e.g., in the candidate's resume, online network profile, etc.) and the job's description.

Title embedding features 224 may be generated from embeddings 214 of job titles and/or titles in the candidates' job histories 212. As shown in FIG. 2, a model-creation apparatus 210 may create a word embedding model 208 from attributes in job histories 212. In turn, word embedding model 208 may generate embeddings 214 based on attributes in profile data 216 and/or jobs data 218. For example, word embedding model 208 may be a word2vec model that outputs embeddings 214 in a vector space based on groupings of standardized attributes in job histories 212 from data repository 134.

More specifically, a collection of standardized job titles, company names, industries, school names, fields of study, and/or other attributes may be generated from each member's job history and inputted into word embedding model 208. For example, each member may be represented by a “document” that is inputted into word embedding model 208. The document may include a “sentence” containing a series of educational attributes (e.g., one or more schools and the corresponding fields of study) followed by a series of job-related attributes (e.g., company, title, and/or industry for each job) from the member's job history. As a result, model-creation apparatus 210 may train word embedding model 208 so that standardized attributes that are shared by a relatively large proportion of job histories 212 are closer to one another in the vector space than standardized attributes that are shared by a smaller proportion of job histories 212. In other words, word embedding model 208 may capture patterns and/or semantic relationships among titles and/or other attributes in job histories 212, so that similarities and/or trends in the attributes within job histories 212 are reflected in distances among embeddings 214 outputted by word embedding model 208.

After word embedding model 208 is created and/or updated, model-creation apparatus 210 stores parameters of word embedding model 208 in a model repository 236. For example, model-creation apparatus 210 may replace old values of the parameters in model repository 236 with the updated parameters, or model-creation apparatus 208 may store the updated parameters separately from the old values (e.g., by storing each set of parameters with a different version number of the corresponding machine learning model).

Model-creation apparatus 210 may also, or instead, provide word embedding model 208 to feature-processing apparatus 204, and feature-processing apparatus 204 may use word embedding model 208 and/or embeddings 214 to generate title embedding features 224 that reflect relationships among attributes in job histories 212. For example, feature-processing apparatus 204 may use word embedding model 208 from model-creation apparatus 210 and/or model repository 236 to generate an embedding of a job title in a job listing. Feature-processing apparatus 204 may also use word-embedding model 208 to produce embeddings of a candidate's current title, past titles, and/or title preferences (e.g., one or more titles that represent the preferred “next step” in the candidate's career path). Feature-processing apparatus 204 may optionally include, with each title inputted into word embedding model 208, additional attributes associated with the title (e.g., industry, company, location, seniority, etc.). Feature-processing apparatus 204 may then calculate a cosine similarity, cross product, Euclidean distance, and/or other measure of vector similarity between the embedding of the job title in the job listing and each embedding of the candidate's current, past, and/or preferred titles.

After job features 220, candidate-job features 222, and/or title embedding features 224 are calculated for one or more candidate-job pairs, feature-processing apparatus 204 may store job features 220, candidate-job features 222, and/or title embedding features 224 in data repository 134 for subsequent retrieval and use. Feature-processing apparatus 204 may also, or instead, provide the features to model-creation apparatus 210, a management apparatus 206, and/or another component of the system for use in generating additional models and/or job recommendations 244 using the features.

More specifically, management apparatus 206 generates recommendations 244 of jobs for one or more sets of candidates based on job features 220, candidate-job features 222, and title embedding features 224. First, management apparatus 206 may retrieve, from model repository 236 and/or model-creation apparatus 210, the latest parameters of one or more machine learning models that generate predictions representing the likelihood that a candidate applies to a job, given the candidate's impression of a listing, description, or recommendation of the job.

Next, management apparatus 206 may use the model parameters and features from feature-processing apparatus 204 to generate a set of scores 240 representing the candidates' likelihoods of applying to the jobs. For example, management apparatus 206 may apply a logistic regression model to job features 220, candidate-job features 222, and/or title embedding features 224 for a candidate-job pair to produce a score from 0 to 1 that represents the probability that the candidate applies to a job recommendation (e.g., recommendations 244) that is displayed to the candidate.

Management apparatus 206 may then generate rankings 242 of the jobs by the corresponding scores 240. For example, management apparatus 206 may rank jobs for a candidate by descending predicted likelihood of applying to the jobs. Finally, management apparatus 206 outputs some or all jobs in rankings 242 as recommendations 244 to the corresponding candidates. For example, management apparatus 206 may display some or all jobs that are ranked by a candidate's descending likelihood of applying to the jobs within a job search tool, email, notification, message, and/or another communication containing job recommendations 244 to the candidate. Subsequent responses to recommendations 244 may, in turn, be used to generate events that are fed back into the system and used to update features, machine learning models, and/or recommendations 244.

By inputting embeddings 214 that capture title transition relationships and/or trends into machine learning models that are used to generate and/or rank job recommendations, the system of FIG. 2 may identify and recommend jobs that are similar and/or relevant to the candidates' job histories 212, independent of the candidates' job searches and/or title preferences. For example, the system may identify strong similarity between a candidate's “Software Engineer” title and corresponding job titles of “Senior Software Engineer,” “Software Developer,” “Lead Software Engineer,” Software Engineer Team Lead,” “System Software Engineer,” and “Software Development Engineer” and increase the presence and/or visibility of the job titles in recommendations 244, even if the candidate has not previously searched for and/or expressed interest in some of the job titles. In contrast, conventional techniques may generate recommendations based on exact matches with the candidates' job search queries and/or title preferences, thereby limiting the recommendations to a small and/or narrow set of jobs. Consequently, the disclosed embodiments may improve computer systems, applications, user experiences, tools, and/or technologies related to user recommendations, employment, recruiting, and/or hiring.

Those skilled in the art will appreciate that the system of FIG. 2 may be implemented in a variety of ways. First, feature-processing apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Feature-processing apparatus 204, model-creation apparatus 210, and management apparatus 206 may additionally be implemented together and/or separately by one or more hardware and/or software components and/or layers.

Second, a number of models and/or techniques may be used to generate embeddings 214, title embedding features 224, scores 240, and/or rankings 242. For example, the functionality of word embedding model 208 may be provided by a Large-Scale Information Network Embedding (LINE), principal component analysis (PCA), latent semantic analysis (LSA), and/or other technique that generates a low-dimensional embedding space from documents and/or terms. Multiple versions of word embedding model 208 may also be adapted to different subsets of candidates (e.g., different member segments in the community), jobs, and/or attributes, or the same word embedding model 208 may be used to generate embeddings 214 and/or title embedding features 224 for all candidates and/or jobs.

Third, the system of FIG. 2 may be adapted to different types of features and/or embeddings 214. For example, word embedding model 208 may be used to generate embeddings 214 and/or corresponding features related to awards, publications, patents, group memberships, profile summaries, and/or other attributes that can be grouped under users or other entities.

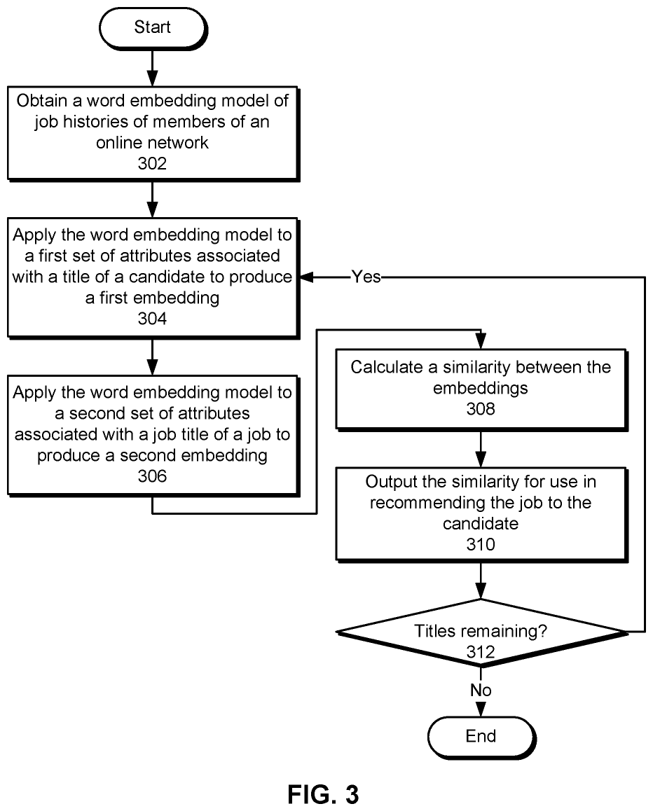

FIG. 3 shows a flowchart illustrating a process of recommending jobs based on title transition embeddings in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

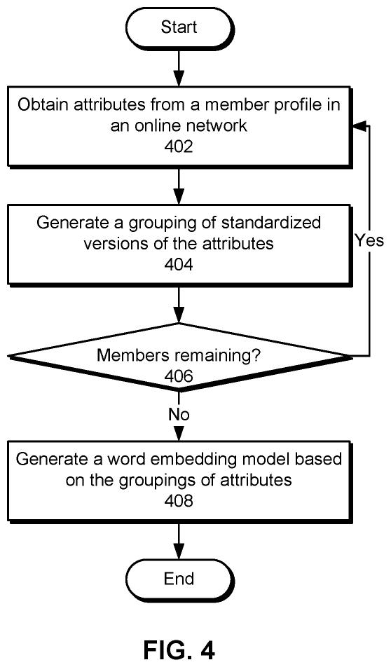

Initially, a word embedding model of job histories of members of an online network is obtained (operation 302), as described in further detail below with respect to FIG. 4. Next, the word embedding model is applied to a first set of attributes associated with a title of a candidate to produce a first embedding (operation 304). For example, the word embedding model may be used to generate an embedding from the candidate's current title, past title or titles, and/or preferred title, as well as optional attributes associated with the title (e.g., the industry, company, seniority, and/or location associated with the title).

The word embedding model is similarly applied to a second set of attributes associated with a job title of a job to produce a second embedding (operation 306). For example, the word embedding model may be used to generate an embedding from the job title and/or the industry, company, seniority, location, and/or another attribute related to the job title.

A similarity between the embeddings is then calculated (operation 308) and outputted for use in recommending the job to the candidate (operation 310). For example, a cosine similarity and/or other type of vector similarity may be calculated between the embedding of the job's title and the embedding of the candidate's current, past, and/or preferred title. The similarity may be inputted into a machine learning model, and the machine learning model may output a score representing a likelihood of the candidate applying to the job. A recommendation of the job to the candidate may then be generated based on a ranking of jobs by score and/or by applying a threshold to the score.

Operations 302-310 may be repeated for remaining titles (operation 312) for the candidate. For example, a separate embedding may be produced for the candidate's current title, each of the candidate's past titles, and/or each of the candidate's preferred titles, and a similarity may be calculated between the embedding and the job title's embedding. The similarity may then be outputted as an indication of the candidate's compatibility with and/or affinity to the job and/or as a feature that is used by a machine learning model to predict the candidate's likelihood of applying to the job.

FIG. 4 shows a flowchart illustrating a process of producing a word embedding model of job histories in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, attributes from a member profile in an online network are obtained (operation 402). For example, the attributes may include a member's current and/or past titles, companies, industries, locations, and/or seniorities. The attributes may also, or instead, include the member's schools, fields of study, degrees, and/or other aspects of the member's educational background.

Next, a grouping of standardized versions of the attributes is generated (operation 404). For example, standardized versions of the attributes may be used to form a “sentence” and/or other collection of words that describe the member's job history and/or educational background.

Operations 402-404 may be repeated for remaining members (operation 406). For example, groupings of standardized education and/or job history attributes may be generated for some or all members of an online network (e.g., online network 118 of FIG. 1) and/or from other sources of job histories (e.g., public records, employment websites, etc.).

The word embedding model is then generated based on the groupings of attributes (operation 408) for the members. For example, a word2vec model may be trained using the groupings, so that embeddings produced by the model reflect relationships and/or trends in the members' education and/or job histories. The model and/or embeddings may subsequently be used to calculate similarities between candidate and job titles and/or recommend jobs to candidates based on the similarities, as discussed above.

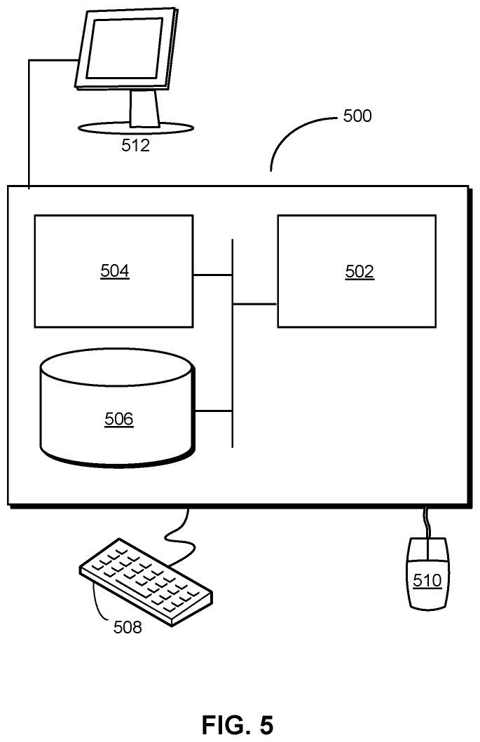

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for recommending jobs based on title transition embeddings. The system includes a feature-processing apparatus, a model-creation apparatus, and a management apparatus, one or more of which may alternatively be termed or implemented as a module, mechanism, or other type of system component. The model-creation apparatus obtains a word embedding model of job histories of members of an online network. Next, the feature-processing apparatus applies the word embedding model to a first set of attributes associated with a title of a candidate to produce a first embedding. The feature-processing apparatus also applies the word embedding model to a second set of attributes associated with a job title of a job to produce a second embedding. The feature-processing apparatus then calculates a similarity between the first and second embeddings. Finally, the management apparatus outputs the similarity for use in recommending the job to the candidate.

In addition, one or more components of computer system 500 may be remotely located and connected to the other components over a network. Portions of the present embodiments (e.g., feature-processing apparatus, model-creation apparatus, management apparatus, data repository, model repository, online network, etc.) may also be located on different nodes of a distributed system that implements the embodiments. For example, the present embodiments may be implemented using a cloud computing system that generates job recommendations and/or embeddings of job and/or education histories for a set of remote users.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a word embedding model of job histories of members of an online network;
applying, by one or more computer systems, the word embedding model to a first set of attributes associated with a current title of a candidate to produce a first embedding;
applying, by the one or more computer systems, the word embedding model to a second set of attributes associated with a job title of a job to produce a second embedding;
calculating, by the one or more computer systems, a first similarity between the first and second embeddings; and
outputting the first similarity for use in recommending the job to the candidate.

2. The method of claim 1, further comprising:
applying the word embedding model to a third set of attributes associated with a title preference for the candidate as input to the word embedding model to produce a third embedding; and
calculating a second similarity between the second and third embeddings.

3. The method of claim 1, further comprising:
applying the word embedding to a third set of attributes associated with a past title of the candidate to produce a third embedding; and
calculating a second similarity between the second and third embeddings.

4. The method of claim 1, further comprising:
applying the word embedding to a third set of attributes associated with an application to another job by the candidate to produce a third embedding; and
calculating a second similarity between the second and third embeddings.

5. The method of claim 1, wherein obtaining the word embedding model comprises:
determining groupings of attributes that reflect the job histories of the members of the online network; and
generating the word embedding model based on the groupings of attributes.

6. The method of claim 5, wherein determining the groupings of attributes that reflect the job histories of the members of the online network comprises:
obtaining attributes from a member profile in the online network; and
including standardized versions of the attributes in the grouping.

7. The method of claim 5, wherein a grouping in the groupings of attributes comprises at least one of:
a previous title;
a current title; and
a company.

8. The method of claim 5, wherein a grouping in the groupings of attributes comprise at least one of:
a school;
a field of study; and
an industry.

9. The method of claim 1, wherein outputting the first similarity for use in recommending the job to the candidate comprises:
inputting the first similarity into a machine learning model;
receiving, as output from the machine learning model, a score representing a likelihood of the candidate applying to the job; and
generating a recommendation of the job to the candidate based on the score.

10. The method of claim 1, wherein the similarity comprises a cosine similarity.

11. The method of claim 1, wherein the first set of attributes comprises at least one of:
the current title;
a current company of the candidate; and
a current industry of the candidate.

12. A system, comprising:
one or more processors; and
memory storing instructions that, when executed by the one or more processors, cause the system to:
obtain a word embedding model of job histories of members of an online network;
apply the word embedding model to a first set of attributes associated with a title of a candidate to produce a first embedding;
apply the word embedding model to a second set of attributes associated with a job title of a job to produce a second embedding;
calculate a similarity between the first and second embeddings; and
output the similarity for use in recommending the job to the candidate.

13. The system of claim 12, wherein the title of the candidate is at least one of:
a current title;
a past title; and
a title preference for the candidate.

14. The system of claim 12, wherein obtaining the word embedding model comprises:
determining groupings of attributes that reflect the job histories of the members of the online network; and
generating the word embedding model based on the groupings of attributes.

15. The system of claim 14, wherein determining the groupings of attributes that reflect the job histories of the members of the online network comprises:
obtaining attributes from a member profile in the online network; and
including standardized versions of the attributes in the grouping.

16. The system of claim 14, wherein a grouping in the groupings of attributes comprises at least one of:
a previous title;
a current title; and
a company.

17. The system of claim 14, wherein a grouping in the groupings of attributes comprise at least one of:
a school;
a field of study; and
an industry.

18. The system of claim 12, wherein the first set of attributes comprises at least one of:
the current title;
a current company of the candidate; and
a current industry of the candidate.

19. A non-transitory computer-readable storage medium storing instructions that when executed by a computer cause the computer to perform a method, the method comprising:
obtaining a word embedding model of job histories of members of an online network;
applying the word embedding model to a first set of attributes associated with a title of a candidate to produce a first embedding;
applying the word embedding model to a second set of attributes associated with a job title of a job to produce a second embedding;
calculating a similarity between the first and second embeddings; and
outputting the similarity for use in recommending the job to the candidate.

20. The non-transitory computer-readable storage medium of claim 19, wherein the title of the candidate is at least one of:
a current title;
a past title; and
a title preference for the candidate.
